(19) United States
(12) Patent Application Publication
(10) Pub. No.: US 2011/0220074 A1
(43) Pub. Date: Sep. 15, 2011

(54) STRATIFIED TWO-STROKE ENGINE AND FUEL

(76) Inventor: Jay Sirangala Veerathappa, Northridge, CA (US)

(21) Appl. No.: 13/047,770

(22) Filed: Mar. 14, 2011

Related U.S. Application Data
(60) Provisional application No. 61/313,801, filed on Mar. 14, 2010.

(51) Int. Cl. F02M 21/04; F02B 25/00; F02M 11/02

(52) U.S. Cl. 123/65 P; 123/525; 261/42; 261/34.1

(57) ABSTRACT

Various embodiments include a two-stroke engine and a carburetor for use with gaseous fuel, such as hydrogen, methane, liquid petroleum gas, pure propane, and butane.

### RELATED APPLICATIONS

The present application claims the benefit of priority of U.S. provisional application No. 61/313,801, filed Mar. 14, 2010, entitled “STRATIFIED TWO-STROKE ENGINE AND FUEL”, the entirety of which is incorporated by reference herein for all purposes.

### BACKGROUND

Conventional gasoline fueled four-stroke engine used in hand-held applications as in a trimmer and a blower sold by Ryobi and MTD and gaseous fueled blower by LEHR are environmentally friendly. However, the drawback is that those engines are very heavy and cannot be operated upside down for extended time and the same design cannot be used in chainsaws. Alternative two-stroke engines are advantageous, but very high in emission levels. Gaseous fueled two-stroke trimmer engine as manufactured and sold by Mitsubishi is a conventional two-stroke engine, which has significantly higher pollutants in the exhaust. Some conventional two-stroke engines sold in US have catalysts to lower the emission levels.

It is known in the engine industry that there are gaseous fueled two-stroke engines with oil injection system. However, these engines are conventional type which have high emission levels and the cleaner stratified engines are gasoline fueled and typically have oil pre-mixed with the gasoline. The disadvantage with gasoline fuel is that they smell bad when spilled and evaporate when stored for longer time. Secondly users have to always pre-mix oil for lubrication, which can harm the catalysts and as such emission levels may be bad toward the end of the life of the catalyst and or the engine. Thirdly, user may forget to mix oil with the gasoline which results in a scuffed engine.

The design described here has a gaseous fueled stratified two-stroke engine with a dual passage carburetor to lower the emissions and oil injection to lubricate the engine. The engine may further be fitted with catalysts to reduce the pollutants to even way below the legal limits. The gaseous fuel may be Butane, CNG, Methane, Hydrogen, or Propane or mixture of any gaseous fuels in any ratio. The engine can be used in many hand-held and lawn garden and mobile applications such as chainsaws, trimmers and scooters.

### BRIEF SUMMARY

The new invention describes the designs of the new two-stroke engine and the carburetor for use with Gaseous fuel, like, H2, Methane, LPG, Pure propane, or Butane. The two-stroke engine is especially best for lawn and garden tools such as chainsaws, trimmers, blowers, pumps, and scooters.

The new invention reduces the emissions significantly with LPG or Butane as fuel and just water vapor and N2 and NOx when H2 is used.

Further, the inventions provide a new lubricating system where in the oil injection pump is driven by the crankshaft or belt or gear drive off of the crankshaft. Alternatively the oil pump may be a diaphragm pump with or without a plunger. The oil may be injected into the intake, particularly into the air-fuel mixture passage, or into the crankcase, and may also be injected into the transfer passage, particularly at the bottom of the passage in a stratified engine where air is drawn into the crankcase through the transfer passage. The gaseous fuel tank is attached to the bottom of the crankcase or at the top of the engine above the cylinder.

### BRIEF DESCRIPTION OF THE DRAWINGS

FIG. 1 is a sectional diagram of a special gaseous fuel carburetor.

FIG. 2 is a line diagram of the gaseous fueled carburetor shown in FIG. 2.

FIG. 3 is a diagram showing the two-stroke engine with charge tube.

FIG. 4 is a sectional diagram of a dual passage gaseous fuel carburetor.

FIG. 4b is a cross sectional diagram of the engine shown in FIG. 4.

FIG. 5 is a line diagram of the gaseous fueled carburetor shown in FIG. 4.

FIG. 6 is a diagram showing the two-stroke engine with air-head stratification.

FIG. 7 shows a three way carburetor, according to some embodiments.

FIG. 8 shows details of the fuel tube 423 and the regulating fuel needle 407, according to some embodiments.

FIG. 9 shows valve regulation, according to some embodiments.

FIG. 10 shows a dual passage gaseous fueled carburetor 8900, according to some embodiments.

### DETAILED DESCRIPTION

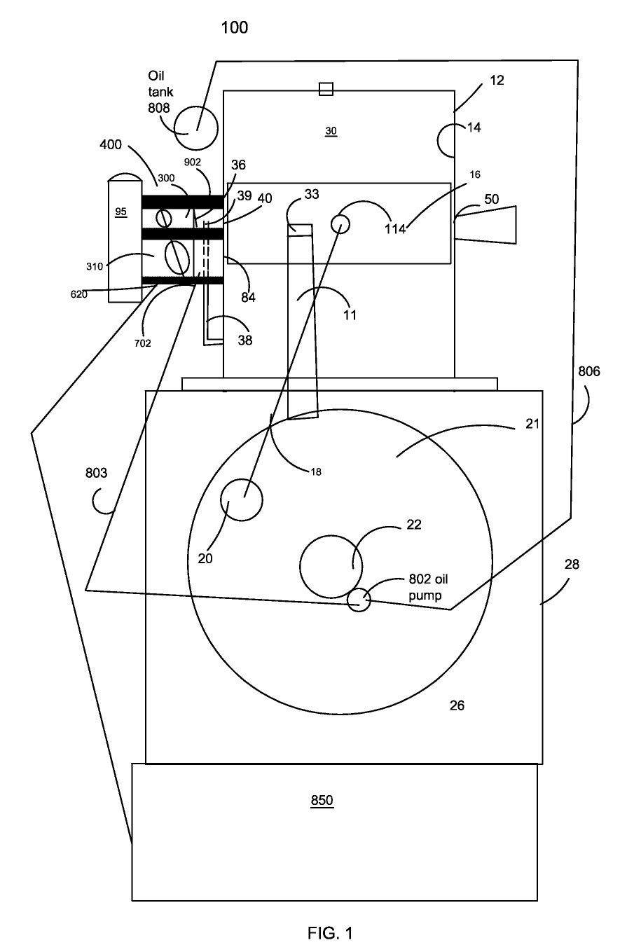

FIGS. 1, through 6 show new two-stroke gaseous fueled oil injected engines with special gaseous fueled carburetors having built in pressure regulator and metering chambers. The two-stroke engine are of stratified type having either a rich charge tube or air-head scavenging as described in U.S. Pat. Nos. 6,901,892, 4,253,433, and 6,273,037. The draw back in the prior arts are that the engines employ gasoline as fuel and oil has to be pre-mixed. The gaseous fuel two-stroke engine made by Mitsubishi as described in U.S. Pat. No. 5,918,574 is not a stratified engine, hence has significantly higher emission levels. The most commonly used gaseous fueled carburetors are not suitable for stratified engines. There are, however, gasoline fueled stratified carburetors, but they are not made to handle gaseous fuels. Therefore it is believed by the inventors that the inventions disclosed here would be beneficial to help the environment and reduce dependence on liquid fuels.

U.S. Pat. No. 6,901,892 for example describes a charge stratified engine in FIG. 1. The operating principle of the innovative engine 100 disclosed in this invention is similar to the engine 10 in the above reference. As such it will be understood by the person who has knowledge of engine will be in a position to execute the disclosed design. Engine 100 in FIG. 1 consists of a cylinder 12 inside which is a reciprocating piston 16 connected to the crankshaft 22 through a connecting rod 18, a crankpin 20 and a piston pin 114. The crankshaft 22 has crank weight 21 and the crankshaft is supported by main bearings either on both ends of a full crank engine or just on one side in a half crank engine. The lower side of the piston has crankcase chamber 26 in the crank case 28. The cylinder 12 has cylinder bore 14 having combustion chamber 30 on the upper side of the piston 16. The crankcase chamber and combustion chamber are interconnected periodically through transfer passage 11. The cylinder has at least one intake port 84, exhaust port 50, at least one transfer port 33 and an injection port 40. The injection port 40 is connected intermittently to the crankcase chamber 26. The lubricating system consists of a oil pump 802 driven by the crankshaft, typically mounted to the side of the crankcase wall. Oil pump 802 has an inlet oil line 806 and receives oil from oil tank 808 and has an outlet pipe 803 injecting oil into the intake passage 310 downstream of the lean valve 80 and possibly into the heat dam 902.

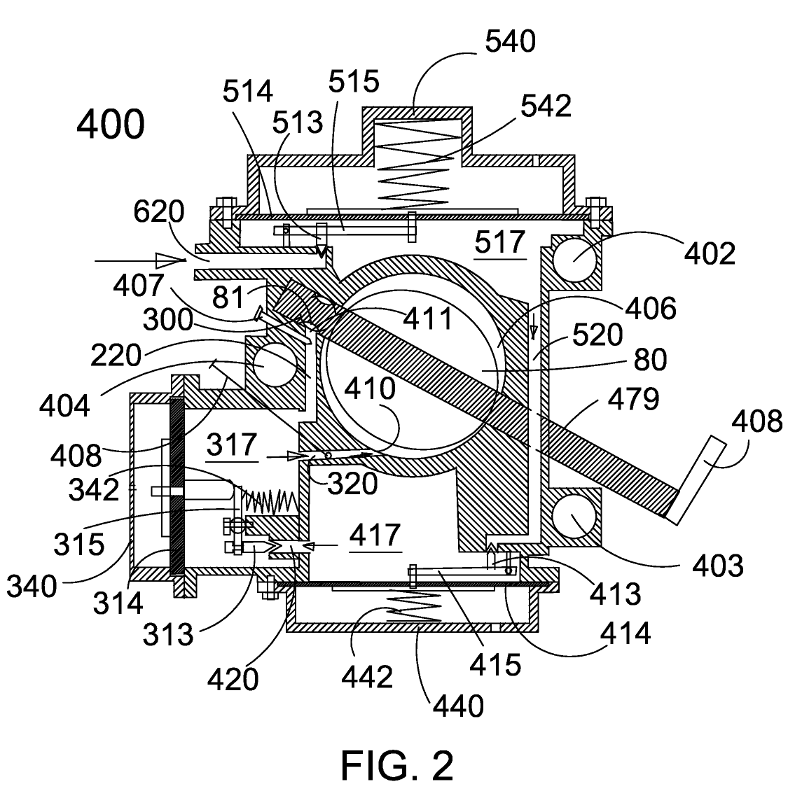

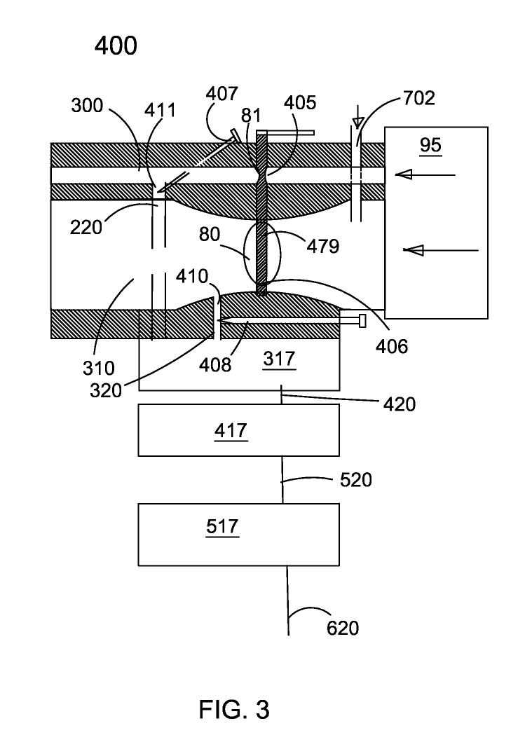

The special gaseous carburetor 400 shown in FIGS. 2 and 3 has at least two passages; a rich charge passage 300 and a lean charge passage 310. The gaseous fuel carburetor has at least one pressure regulating chamber and a metering chamber 317. The carburetor disclosed here has a high pressure fuel inlet 620 supplying fuel into a high pressure chamber 517. High pressure chamber 517 has a diaphragm 514 and a high pressure needle valve 513 activated through a high pressure arm 515. The diaphragm 514 has a spring 542 on the ambient side of the diaphragm and the spring and the diaphragm are held in place by the high pressure chamber cover 540. The ambient side of the diaphragm is at ambient pressure. The high pressure chamber 517 is connected to a low pressure chamber 417 through a high pressure fuel passage 520. Similar to the high pressure chamber 517, the low pressure chamber has a low pressure needle valve 413, diaphragm 414, arm 415, a spring 442 and a cover 440. The low pressure chamber 417 is connected to a metering chamber 317 through a low pressure fuel passage 420. The metering chamber also has a metering chamber needle valve 313 activated by the metering chamber arm 315. The metering chamber diaphragm is pushed outward by a metering chamber spring 342, which also acts against the metering chamber needle valve 313 to keep the fuel flowing from low pressure chamber 417 to the metering chamber 317 when the engine is not running and when the pressure across the metering chamber diaphragm 314 is same is zero, that is; the pressure in the metering chamber 317 is same as ambient. Fuel can flow into the metering chamber 317 only when the pressure in the chamber 317 is sub atmospheric and thus preventing any fuel leak into the intake passage when the engine is dead.

When the engine is running, the sub atmospheric pressure intake passages 406 and 300 is sub-atmospheric, the pressure in the metering chamber 317 also drops to sub atmospheric causing the diaphragm to move inward against the spring 342, thus opening the needle valve 313 to open. The metering chamber has lean fuel passage 320 to the lean passage 310 opening at the fuel orifice 410, preferably at the venture 406 and may have more than one orifice as described in gasoline carburetors in the prior arts. The metering chamber 317 also has a rich fuel passage 220 supplying fuel to the rich passage 300 through the fuel orifice 411. The fuel flow to the fuel passages 320 and 220 are adjustable through the respective screws 408 and 407.

As the pressure in the metering chamber 317 drops, the metering needle valve 313 is lifted off its seat letting the fuel to flow in from the low pressure chamber 417 through the passage 420. In turn, when the pressure in the low pressure chamber 417 drops, the low pressure needle valve 413 is lifted off its seat, because the needle 413 is activated by the low pressure arm 415 attached to the low pressure diaphragm 414, which is pushed downward by the low pressure spring 442. The diaphragm 414 and the low pressure spring is held in place by the low pressure chamber cover 440. When the pressure in the low pressure chamber 417 drops, the low pressure needle valve 413 opens and the fuel flows from the high pressure chamber 517 to the low pressure chamber 417 through the high pressure passage 520. The drop in pressure in the high pressure chamber 517 causes the high pressure diaphragm 514 to move downward thus the high pressure needle valve 513 is lifted off its seat letting the high pressure fuel to flow from the high pressure fuel tank 700 through the fuel inlet 620. As described, the pressure drops in stages from high pressure to the almost atmospheric in the metering chamber 317. The gaseous fuel stored in a propane or butane tank 700, for example in a Coleman's propane fuel tank is at about 100 psi or a Butane fuel tank commonly used by Mitsubishi's trimmer engine is at a lower pressure.

The gaseous carburetor 400 has a rich charge passage 300 supplying rich charge (rich fuel-air mixture) into the injection tube 38, through a one way valve 36 in the intake heat dam 902. As described in prior art, U.S. Pat. Nos. 6,901,892 and 6,293,235. The lean passage 310 supplies lean charge (lean fuel-air mixture) with oil into the crankcase chamber 26. The intake and scavenging process is explained in detail in the prior arts U.S. Pat. No. 6,901,892 and others. It is to be known that person skilled in the art understands the operating principle by reading the prior arts U.S. Pat. Nos. 6,901,892 and 6,293,235 in its entirety. However, in this invention, the oil is injected into lean charge in the lean passage 310, preferably at the intake heat dam 902. The flow of rich and the lean charge into the engine are regulated by the respective control valves 81 and 80. Both the valves 81 and 80 are mounted on to a common throttle shaft 479. However, they may be mounted on separate throttle shafts linked to each other and may be at phase with each other. Also, in the disclosure, the undercut (or a through hole) in the throttle shaft 479 in the rich charge passage may act as a throttle valve 81 and not have a separate valve. It must be understood that the dual valves may be of any type; butterfly valve, rotary valve also known as barrel valves, or slide valve, which are commonly known to the person skilled in the art. The passages of the carburetors 400 and 8400 may be one piece or may be two separate bodies.

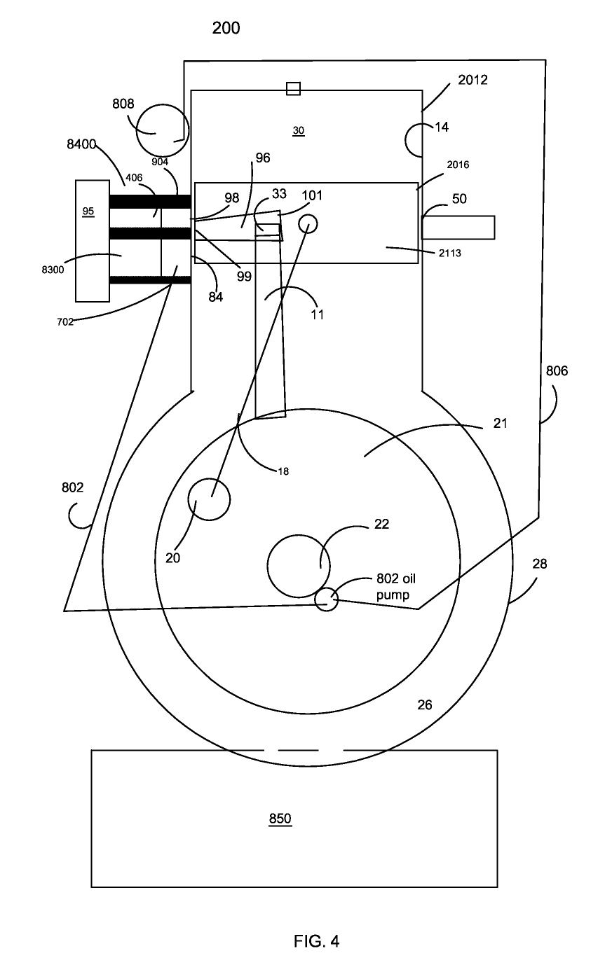

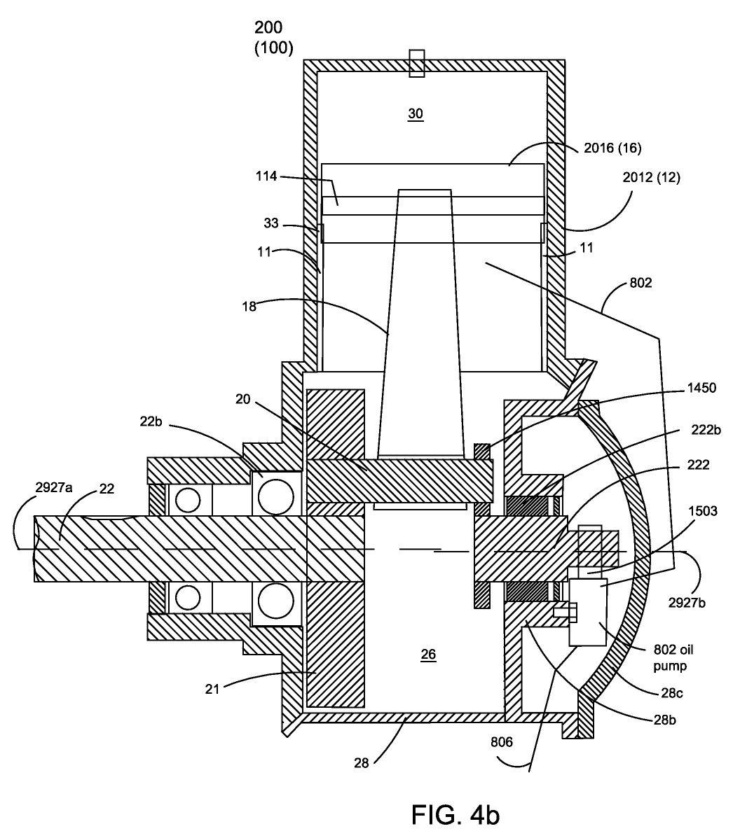

Further the invention discloses a dual passage carburetor 8400 for air-head stratified engines. Prior arts U.S. Pat. Nos. 6,901,892 and 6,112,708 describe in detail the operating principle of a air-head stratified engine. Engine 200 in FIG. 4 consists of a cylinder 2012 inside which is a reciprocating piston 2016 connected to the crankshaft 22 through a connecting rod 18, a crankpin 20 and a piston pin 114. The crankshaft 22 has crank weight 21 and the crankshaft is supported by main bearings either on both ends of a full crank engine or just on one side in a half crank engine. An outboard shaft 222 loosely connected to the crankpin 20 through a yoke 1450 is shown in FIG. 4b, which is a sectional view of the half crank engine 200. An oil pump 802 may be driven by the outboard shaft 222. As shown the axis 2927a of the crankshaft 22 and the axis 2927b of the outboard shaft 222 may not be in line and is not critical to be in line, because the yoke 1450 has a slot and accounts for any misalignment between the shafts. The lower side of the piston has crankcase chamber 26 in the crank case 28. The cylinder 2012 has cylinder bore 14 having combustion chamber 30 on the upper side of the piston 2016. The crankcase chamber 26 and combustion chamber 30 are interconnected periodically through transfer passage 11 and transfer port 33. The cylinder 2012 has at least one intake port 84 for air-fuel mixture, at least one air inlet port, exhaust port 50, and at least one transfer port 33. The engine operates like a conventional two-stroke engine. First and second piston ports 99 and 101 are disposed on the skirt 2113 of the piston 2016 and are connected to each other in gaseous communication by air channel 96. The complete description of the air-head engine is described in entirety in the U.S. Pat. No. 6,901,892. The lubricating system consists of a oil pump 802 driven by the crankshaft, typically mounted to the side of the crankcase wall. Oil pump 802 has an inlet oil line 806 and receives oil from oil tank 808 and has an outlet pipe 803 injecting oil into the intake passage 310 downstream of the lean valve 80 and possibly into the heat dam 904. The engine 200 described is referred to as a piston ported air-head engine. It must be understood that the air-head stratified engine may also be a reed valve air-head stratified engine, where in the air is inducted into the transfer passage 11 through a reed valve) also known as one-way valve) as described in U.S. Pat. No. 6,901,892 in FIG. 31. However, it is optional to have rotary valve open and close the opening of the transfer passage in the crankcase chamber. An outboard shaft (222) driven oil pump is also described in FIG. 25 in the U.S. provisional application 61/252,695 filed Oct. 18, 2009 and in the U.S. provisional application 61/277,476 filed Sep. 26, 2009.

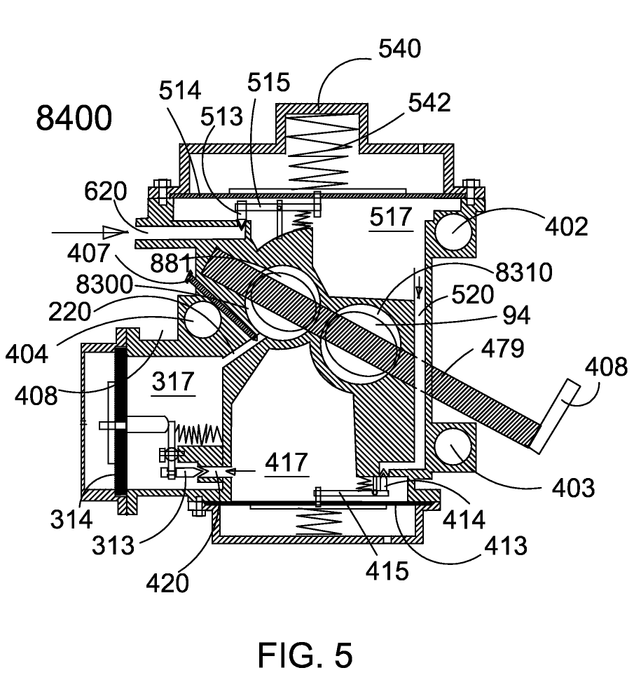

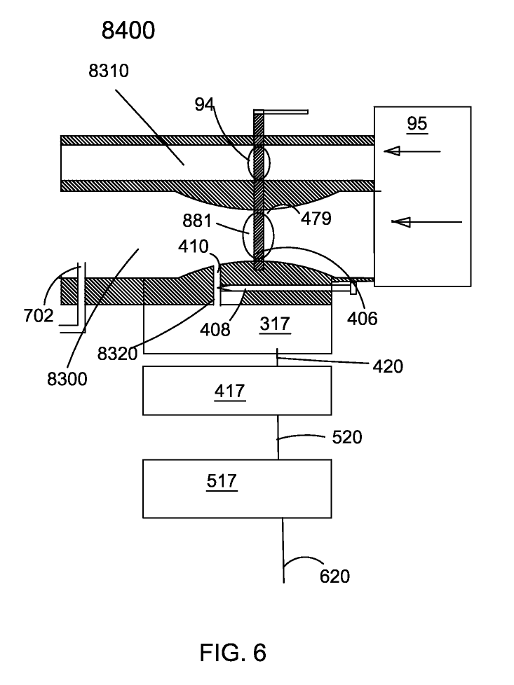

Further, the dual passage gaseous carburetor 8400 shown in FIGS. 6 and 7 have common pressure regulating and metering parts as described with respect to carburetor 400. As such description and operating principle will not be repeated. However, the main difference between the carburetor 400 and 8400 is that in carburetor 8400, only the air-fuel passage 8300 is supplied with the gaseous fuel through a fuel passage 8320 from the fuel metering passage 317, whereas, the air passage 8310 supplies only pure air into the transfer passages. Air-fuel mixture and air are regulated by the respective air-fuel valve 881 and air valve 94 respectively. Fuel is adjusted with the fuel adjusting screw 408. The oil is injected into the air-fuel passage 8300 at downstream of the air-fuel valve 881 through an oil injector. The oil may also be injected directly into the crankcase chamber 26 through the side wall of the crankcase 28 or may also be injected through a central hole in the crankshaft 22 and through a cross drilled hole in the counter weight (not shown). When injected directly into crankcase chamber or through crankshaft, it eliminates the need for oil feed line 803. Also, the oil tank may be attached to the side of the crankcase on the outside between the starter housing and the crankcase outer wall. It must be understood that the carburetors 400 and 8400 may be combined to form a three-way carburetor as described in U.S. Pat. No. 6,901,892, however, it will be a gaseous fuel with oil injection into lean charge passage. Also, the control valves may be of any type; butterfly valve, barrel or rotary valve, or slide valve.

It is also possible for rich fuel to be inducted into the injection tube 38 and the opening into the crankcase chamber 26 be periodically opened and closed by the cut out on the counter weight 21, as described in the prior art U.S. Pat. No. 6,901,892. Also, it is possible that the pure air with or without oil injected into the air be inducted into the crankcase chamber 26 through transfer ports 33 as in the air-head engine described in U.S. Pat. No. 6,901,892, where as the air inlet is through a one way valve or through the air channel in the piston as described in U.S. Pat. No. 6,901,892.

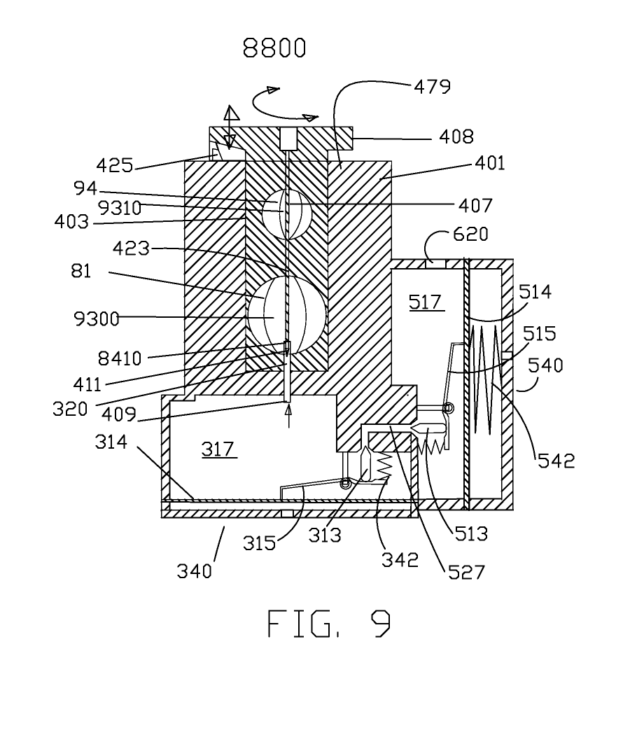

The two-way carburetor 8800 is illustrated in more detail in FIG. 9 and the engine is illustrated in detail in FIG. 4. As the piston 2113 ascends in the cylinder bore 14 of the engine, the pressure in the crankcase chamber 26 drops below ambient. The differential pressure between the crankcase chamber 26 and the ambient (outside of the carburetor) causes air to flow into the crankcase chamber 26 through the appropriate passages (transfer passages or charge passages). There are two flow transversely extending venturi passages in a longitudinally extending barrel 403 of a two-way carburetor. An air venturi passage 404 allows only air, which is regulated by the air control barrel valve 94, to flow into the transfer passage 11. A charge venturi passage 405 flows a air-fuel mixture regulated by a charge barrel valve 81 into the charge passage 406 directly into the crankcase chamber 26. The air control and charge barrel valves are mounted on a rotatable barrel valve body 403 in a gaseous carburetor body 401.

Further, the dual passage gaseous carburetor 8800 shown in FIG. 9 have common pressure regulating and metering parts as described with respect to carburetor 8400. As such description and operating principle will not be repeated. However, the main difference between the carburetor 8800 and 8400 is that in carburetor 8800, the regulating valves for only air and for air-fuel mixtures are the rotary barrel valves 94 and 81 respectively are on a single barrel valve body 403. Also, it should further be noted that there is at least one pressure regulating chamber 517 connected to the metering chamber 417 through a passage 527. The passage 320 is in the form of a tube extending through the barrel valve body and opening into the air-fuel charge venture passage 405. The fuel tube 320 in this carburetor 8800 extends slightly into the metering chamber 417. The amount of fuel is regulated by a needle valve 423 having a tapered end 411 at the lower tip of the needle 423. Alternately, the fuel tube 320 may have a slot or opening at the upper tip in triangular shape, while the regulating needle id cylindrical in shape. As the needle 423 is sliding up and down as the barrel valve body 403 is rotated, the amount of fuel is also varied. The barrel valve body 403 is resting on a wedge 425 and the top of the barrel valve body 403 has a flat disc 408 having a ramp on the lower surface. Thus as the valve body 403 is rotated, the ramp on the wedge forces the valve body 403 to rise as well, which in turn rises the fuel control needle 423. The tapered shape of the needle in the fuel tube 314 varies the flow area for the fuel. Thus the fuel and air are concurrently varied.

The pressure regulating chamber 517 and metering chamber 417 are integral to the barrel valve carburetor body 401.

Further FIG. 7 shows a three way carburetor 8900, in which there are three barrel valves 94, 81, and 80 are respectively control only air, rich charge, and lean charge. The three valves are mounted on a rotatable barrel valve body 803 in a gaseous fuel carburetor body 801. The operating principle of the gaseous carburetor 8900 is similar to the carburetor 8800.

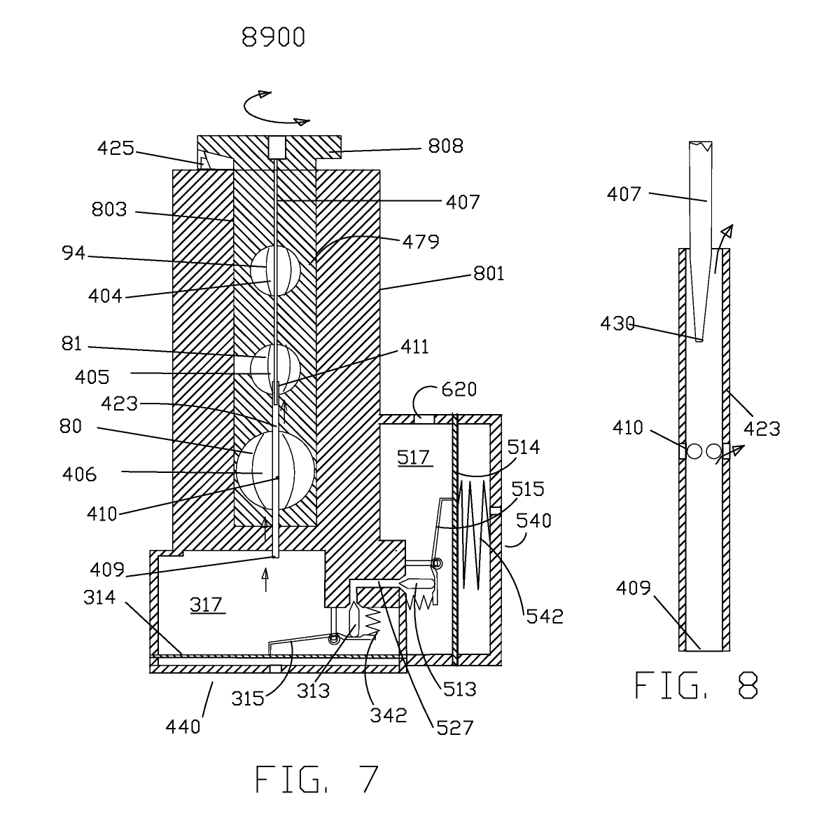

FIG. 8 shows details of the fuel tube 423 and the regulating fuel needle 407. It shows that the fuel needle 407 having a tapered tip 430. As the fuel needle 407 slides upward the effective flow area for the fuel increases.

Please refer to U.S. Pat. No. 6,901,892 for details of three way carburetor.

In FIG. 9, for example, the passage or the air fuel mixture could be regulated by a rotary valve, whereas the air passage could be regulated by a butterfly valve, where the two valves are connected by some kind of linkage. Similarly, the air fuel mixture passage could be regulated by a butterfly valve, with the air passage regulated by a rotary valve. In this case too, the valves could be connected by a linkage.

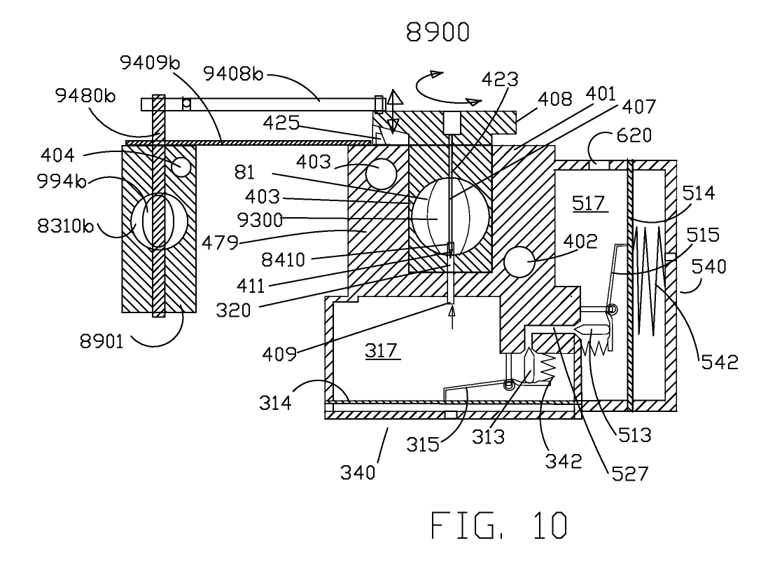

FIG. 10 shows the a dual passage gaseous fueled carburetor 8900 having a rotary barrel valve 81 for the regulation air-fuel mixture in a similar way explained for the dual passage gaseous carburetor 8800 shown in FIG. 9. However, valve for regulating the air only passage is now a butterfly valve 994b, in a separate body 8901, interconnected by a linkage 9408b to the flat disc 408 on the barrel valve body 403. The body 8901 of the butter fly valve 994b could be rigidly mounted to the gaseous fuel barrel valve carburetor body 401 through a rigid body 9409b.

The following are embodiments, not claims:
A. A gaseous fueled dual passage carburetor 400 comprising:
   a. a lean passage 310;
   b. a lean valve 80;
   c. a rich charge passage 300;
   d. a rich valve 81;
   e. at least one pressure regulating chamber with a diaphragm, spring, and a needle valve;
   f. a first fuel passage 320 leading into the lean passage 310; a second fuel passage 220 leading into the rich charge passage 300;
   g. a fuel tank (850);
   h. a gaseous fuel inlet (620) receiving fuel from the fuel tank (850);
   i. a venture (406);
   j. a first fuel orifice (410) in the venture (406); and
   k. a second fuel orifice (411) in the rich charge passage (300).
B. The carburetor (400) of embodiment A in which the both the lean valve 80 and rich valve 81 are control valves.
C. The carburetor (400) of embodiment B in which control valves 80 and 81 are on one shaft (479).
D. The carburetor (400) of embodiment C in which control valves 80 and 81 are each butterfly valves, and are each cut out on the shaft (479).
E. The carburetor (400) of embodiment A in which the both the lean valve 80 and rich valve 81 are rotary valves.
F. The carburetor (400) of embodiment A in which the lean valve 80 is a butterfly valve and the rich valve 81 is a rotary valve.
G. The carburetor (400) of embodiment A further including three mounting holes 402, 403, and 404.
H. The carburetor 400 of embodiment A, in which the carburetor is embedded within an engine, the engine including a crankshaft 106, an attached LPG or Butane fuel tank, and a separate oil tank 140 shaped such as to access oil at all engine attitudes, the carburetor 400 further comprising:
   a. an oil injector 702 for injecting oil into the passage 310; and
   b. an oil injection pump 138 driven by the crankshaft 106.
I. The carburetor (400) of embodiment A further comprising an internal combustion engine.
J. A gaseous fueled two-stroke engine 100 having a gaseous carburetor 400 with an oil injection pump 138 driven by a crankshaft 106 with an LPG or Butane fuel tank attached to the engine and a separate oil tank 140 shaped such as to access oil at all engine attitudes.
K. The engine of embodiment 10 having a cylindrical fuel tank.
L. The engine 200 of embodiment 10 having at least one air inlet port 98, at least one air channel 96, at least one first piston port 99, at least one second piston port 99, a transfer passage 11, a transfer port 33, an exhaust port 50, and a piston 2016 reciprocating in the cylinder 2012.
M. An internal combustion engine comprising:
   i. a cylinder (12);
   ii. a cylinder bore (14);
   iii. a crankshaft (22);
   iv. a piston (16) connected to the crankshaft (22) having a counter weight (21);
   v. a crankcase chamber (26);
   vi. a combustion chamber (30);
   vii. at least one injection port (40) intermittently open to the combustion chamber (30);
   viii. an injection tube (38) intermittently filled with gaseous fuel, and intermittently connected to the crankcase chamber (26);
   ix. a oil injection pump (802) driven by the crankshaft (22);
   x. a oil tank (140);
   xi. at least one intake port (84);
   xii. at least one exhaust port (50); and
   xiii. an oil injector (702),
   xiv. in which the gaseous fuel is significantly free of oil.
N. The engine of embodiment M further comprising an injection tube (38) intermittently filled with air and fuel.
O. The engine of embodiment M in which the injection tube (38) is intermittently filled with fuel only.
P. The engine of embodiment M, in which the piston makes repeated cycles, and in which, on each cycle the injection tube (38) is filled with gaseous fuel only, which is added to residual gas remaining from a previous cycle.
Q. The engine of embodiment M further comprising an intake port (84) intermittently supplying only air into crankcase chamber (26).
R. The engine of embodiment M in which oil is injected into intake air.
S. The engine of embodiment M in which oil is injected into air-fuel mixture.
T. The engine of embodiment M, further comprising a transfer passage, in which oil is injected into the transfer passage.
U. The engine of embodiment M in which oil is injected into crankcase chamber (26) through a passage in crankshaft (22).
V. The engine of embodiment M further comprising a heat dam (904) in which oil is injected into the heat dam (904).
W. An internal combustion two-stroke engine (200) comprising:
   i. a cylinder (2012) and a cylinder bore (14);
   ii. a crankshaft (22) having a counter weight (21);
   iii. a piston (2016) connected to the crankshaft (22),
   iv. in which the piston has a piston skirt (2113) and at least one air channel (96) on the piston skirt (2113);
   v. at least one first port (99) and at least one second port (101), the first and second ports intermittently aligning with at least one air inlet port 98 and at least one transfer port 33, respectively;
   vi. a crankcase chamber (26),
   vii. an oil injection pump (802) driven by the crankshaft (22);
   viii. an oil tank (140);
   ix. at least one exhaust port (50);
   x. an oil injector (702);
   xi. at least one intake port (84), in which a gaseous fuel is inducted through intake port (84) and oil is injected into crankcase chamber 26 through intake port 84;
   xii. and a dual passage gaseous carburetor (8400).
X. The engine of embodiment W further comprising a gaseous fuel tank (850).
Y. The engine of embodiment W in which the oil tank is separated from the engine.
Z. An internal combustion engine comprising:
   i. a cylinder (2012) and a cylinder bore (14);
   ii. a crankshaft (22) having a counter weight (21);
   iii. a piston (2016) connected to the crankshaft (22),
   iv. in which the piston (2016) has at least one air channel (96) on the piston skirt (2113);
   v. at least one air inlet port (98);
   vi. at least one transfer port (33);
   vii. at least one first port (99) and at least one second port (101), in which the first and second ports intermittently align with the at least one air inlet port (98) and the at least one transfer port (33), respectively;
   viii. a crankcase chamber (26) receiving intermittent injections of oil;
   ix. a combustion chamber (30);
   x. at least one injection port (40) intermittently open to the combustion chamber (30);
   xi. a injection tube (38), the injection tube (38) intermittently filled with gaseous fuel that is significantly free of oil; and intermittently connected to the crankcase chamber (26);
   xii. an oil injection pump (802) driven by the crankshaft (22);
   xiii. an oil tank (140);
   xiv. at least one first piston port (99);
   xv. at least one second port (101); and
   xvi. at least one exhaust port (50).
AA. A gaseous fueled carburetor comprising:
   a. at least one pressure regulator;
   b. at least one metering chamber;
   c. a first valve for air-fuel regulation;
   d. a second valve for air only; and
   e. a linkage between the two valves.
BB. The carburetor of embodiment AA in which the first valve is a rotary valve and the second valve is a butterfly valve.
CC. The carburetor of embodiment AA in which the first valve is a butterfly valve and the second valve is a rotary valve.
DD. A gaseous fueled dual passage carburetor 8400 comprising:
   a. an air passage 8310 and air-fuel passage 8300, with each passage controlled by respective control valves 94 and 881;
   b. at least one pressure regulating chamber which includes a diaphragm, spring, and needle valve;
   c. a fuel metering chamber 317 operable to supply fuel into the air-fuel passage 8300 at sub atmospheric pressure.
EE.A gaseous fueled carburetor 8900 having:
   a barrel valve 81 for regulating the air-fuel mixture;
   at least one butter fly valve 994b for regulating the air,
   butterfly valve 99b and barrel valve 81 inter connected by means of a linkage 9408b,
   having at least one pressure regulating chamber 517,
   at least one metering chamber 317
FF. A gaseous fueled carburetor 8900 having:
   a barrel valve 81 for regulating the air-fuel mixture;
   at least one butter fly valve 994b for regulating the air,
   butterfly valve 99b and barrel valve 81 inter connected by means of a linkage 9408b,
   having at least one pressure regulating chamber 517,
   at least one metering chamber 317,
   barrel valve body having at least one mounting hole 402 (and 403), and;
   butterfly valve body 8901 having at least one mounting hole 404.

Various embodiments include a carburetor that advantageously has a built-in pressure regulating chamber, because fuel supplied to carburetor is already under pressure. Various embodiments utilize a fuel compresing liquified petroleum gas. In some embodiments, the fuel could be natural gas, hydrogren gas, or any type of fuel essentially free of oil.

### PARTS LIST

100 Engine
11 transfer passage
12 Cylinder
14 cylinder wall
16 Piston
18 connecting rod
20 crank pin
22 crankshaft
26 crankcase chamber
28 crankcase
30 Combustion chamber
33 transfer port
36 One way valve
38 Injection tube
40 charge injection port
50 Exhaust port
80 Lean valve
81 Rich valve
84 Intake port
95 Airfilter box
101 Piston pin
220 Rich fuel passage
300 Rich charge passage
310 Lean passage
313 Meetering needle valve
314 Meetering diaphrgam
315 Metering arm
317 Metering chamber
320 Lean fuel passage
340 Metering chamber cover
342 Metering chamber spring
400 Gaseous fuel carburetor
402 Mounting hole
403 Mounting hole
404 Mounting hole
406 venturi
407 Rich fuel adjusting screw
408 Lean fuel adjusting screw
408 Throttle lever
410 Lean orifice
411 Rich orifice
413 Low pressure needle valve
414 Low pressure diaphragm
415 Low pressure arm
417 Low pressure chamber
440 Low pressure cover
   Low pressure chamber
442 spring
479 Throttle shaft
513 Hi pressure needle valve
514 High pressure diaphragm
515 High pressure arm
517 High pressure chamber
520 High pressure fuel passage
540 High pressure cover
   High pressure chamber
542 spring
620 Fuel inlet
702 Oil injector
802 oil outlet tube
804 oil pump
806 oil inlet tube
808 oil tank
850 Gaseous fuel tank
902 Heat dam
200 Engine
94 Air valve
96 air channel
98 Air inlet port
99 first piston port
101 second piston port
406 Air passage
881 Air-fuel valve
904 Heat dam
2012 Cylinder
2016 Piston
2113 piston skirt
8300 Air-fuel passage
8310 Air passage
8320 Fuel passage
   Dual passage gaseous
8400 Carburetor

It is to be understood that other modifications of the invention shall be apparent to those skilled in the art from the teachings herein and, it is, therefore, desired to be secured in the appended claims all such modifications as fall within the true spirit and scope of the invention.

Accordingly, what is desired to be secured by Letters Patent of the United States is the invention as defined and differentiated in the following claims:

1. A gaseous fueled dual passage carburetor 400 comprising:
a lean passage 310;
a lean valve 80;
a rich charge passage 300;
a rich valve 81;
at least one pressure regulating chamber with a diaphragm, spring, and a needle valve;
a first fuel passage 320 leading into the lean passage 310; a second fuel passage 220 leading into the rich charge passage 300;
a fuel tank (850);
a gaseous fuel inlet (620) receiving fuel from the fuel tank (850);
a venture (406);
a first fuel orifice (410) in the venture (406); and
a second fuel orifice (411) in the rich charge passage (300).

2. The carburetor (400) of claim 1 in which the both the lean valve 80 and rich valve 81 are control valves.

3. The carburetor (400) of claim 2 in which control valves 80 and 81 are on one shaft (479).

4. The carburetor (400) of claim 3 in which control valves 80 and 81 are each butterfly valves, and are each cut out on the shaft (479).

5. The carburetor (400) of claim 1 in which the both the lean valve 80 and rich valve 81 are rotary valves.

6. The carburetor (400) of claim 1 in which the lean valve 80 is a butterfly valve and the rich valve 81 is a rotary valve.

7. The carburetor (400) of claim 1 further including three mounting holes 402, 403, and 404.

8. The carburetor 400 of claim 1, in which the carburetor is embedded within an engine, the engine including a crankshaft 106, an attached LPG or Butane fuel tank, and a separate oil tank 140 shaped such as to access oil at all engine attitudes, the carburetor 400 further comprising:
an oil injector 702 for injecting oil into the passage 310; and
an oil injection pump 138 driven by the crankshaft 106.

9. The carburetor (400) of claim 1 further comprising an internal combustion engine.

10. A gaseous fueled two-stroke engine 100 having a gaseous carburetor 400 with an oil injection pump 138 driven by a crankshaft 106 with an LPG or Butane fuel tank attached to the engine and a separate oil tank 140 shaped such as to access oil at all engine attitudes.

11. The engine of claim 10 having a cylindrical fuel tank.

12. The engine 200 of claim 10 having at least one air inlet port 98, at least one air channel 96, at least one first piston port 99, at least one second piston port 99, a transfer passage 11, a transfer port 33, an exhaust port 50, and a piston 2016 reciprocating in the cylinder 2012.

13. An internal combustion engine comprising:
a cylinder (12);
a cylinder bore (14);
a crankshaft (22);
a piston (16) connected to the crankshaft (22) having a counter weight (21);
a crankcase chamber (26);
a combustion chamber (30);
at least one injection port (40) intermittently open to the combustion chamber (30);
an injection tube (38) intermittently filled with gaseous fuel, and intermittently connected to the crankcase chamber (26);
a oil injection pump (802) driven by the crankshaft (22);
a oil tank (140);
at least one intake port (84);
at least one exhaust port (50); and
an oil injector (702),
in which the gaseous fuel is significantly free of oil.

14. The engine of claim 13 further comprising an injection tube (38) intermittently filled with air and fuel.

15. The engine of claim 13 in which the injection tube (38) is intermittently filled with fuel only.

16. The engine of claim 13, in which the piston makes repeated cycles, and in which, on each cycle the injection tube (38) is filled with gaseous fuel only, which is added to residual gas remaining from a previous cycle.

17. The engine of claim 13 further comprising an intake port (84) intermittently supplying only air into crankcase chamber (26).

18. The engine of claim 13 in which oil is injected into intake air.

19. The engine of claim 13 in which oil is injected into air-fuel mixture.

20. The engine of claim 13, further comprising a transfer passage, in which oil is injected into the transfer passage.

21. The engine of claim 13 in which oil is injected into crankcase chamber (26) through a passage in crankshaft (22).

22. The engine of claim 13 further comprising a heat dam (904) in which oil is injected into the heat dam (904).

23. An internal combustion two-stroke engine (200) comprising:
a cylinder (2012) and a cylinder bore (14);
a crankshaft (22) having a counter weight (21);
a piston (2016) connected to the crankshaft (22),
in which the piston has a piston skirt (2113) and at least one air channel (96) on the piston skirt (2113);
at least one first port (99) and at least one second port (101), the first and second ports intermittently aligning with at least one air inlet port 98 and at least one transfer port 33, respectively;
a crankcase chamber (26),
an oil injection pump (802) driven by the crankshaft (22);
an oil tank (140);
at least one exhaust port (50);
an oil injector (702);
at least one intake port (84), in which a gaseous fuel is inducted through intake port (84) and oil is injected into crankcase chamber 26 through intake port 84;
and a dual passage gaseous carburetor (8400).

24. The engine of claim 23 further comprising a gaseous fuel tank (850).

25. The engine of claim 23 in which the oil tank is separated from the engine.

26. An internal combustion engine comprising:
a cylinder (2012) and a cylinder bore (14);
a crankshaft (22) having a counter weight (21);
a piston (2016) connected to the crankshaft (22),
in which the piston (2016) has at least one air channel (96) on the piston skirt (2113);
at least one air inlet port (98);
at least one transfer port (33);
at least one first port (99) and at least one second port (101), in which the first and second ports intermittently align with the at least one air inlet port (98) and the at least one transfer port (33), respectively;
a crankcase chamber (26) receiving intermittent injections of oil;
a combustion chamber (30);
at least one injection port (40) intermittently open to the combustion chamber (30);
a injection tube (38), the injection tube (38) intermittently filled with gaseous fuel that is significantly free of oil; and intermittently connected to the crankcase chamber (26);
an oil injection pump (802) driven by the crankshaft (22);
an oil tank (140);
at least one first piston port (99);
at least one second port (101); and
at least one exhaust port (50).

27. A gaseous fueled carburetor comprising:
at least one pressure regulator;
at least one metering chamber;
a first valve for air-fuel regulation;
a second valve for air only; and
a linkage between the two valves.

28. The carburetor of claim 27 in which the first valve is a rotary valve and the second valve is a butterfly valve.

29. The carburetor of claim 27 in which the first valve is a butterfly valve and the second valve is a rotary valve.

30. A gaseous fueled dual passage carburetor 8400 comprising:
an air passage 8310 and air-fuel passage 8300, with each passage controlled by respective control valves 94 and 881;
at least one pressure regulating chamber which includes a diaphragm, spring, and needle valve;
a fuel metering chamber 317 operable to supply fuel into the air-fuel passage 8300 at sub atmospheric pressure.

31. An internal combustion engine (200) comprising:
a cylinder (2012) and a cylinder bore (14);
a crankshaft (22) having a counter weight (21);
an outboard shaft (222) having a yoke (1450);
a piston (2016) connected to the crankshaft (22) through a connecting rod (18) and a crankpin 20;
at least one transfer port (33);
at least one intake port 84;
at least one exhaust port 50;
a combustion chamber (30);
a crankcase chamber (26) intermittently connected to the combustion chamber (30); and
an oil injection pump (802) driven by the outboard shaft (222).

32. An internal combustion engine as claimed in claim 31, further comprising:
a crankcase cover (28b); and
an oil pump (802) mounted on the crankcase cover (28b).
